(19) United States
(12) Patent Application Publication
(10) Pub. No.: US 2023/0022712 A1
(43) Pub. Date: Jan. 26, 2023

(54) METHOD, APPARATUS, AND COMPUTER PROGRAM FOR RECOMMENDING FASHION PRODUCT

(71) Applicant: ODD CONCEPTS INC., Seoul (KR)

(72) Inventors: Ae Ri YOO, Namyangju-si (KR); Su Hae SHIN, Ansan-si (KR)

(73) Assignee: ODD CONCEPTS INC., Seoul (KR)

(21) Appl. No.: 17/767,134

(22) PCT Filed: Oct. 7, 2020
(86) PCT No.: PCT/KR2020/013651

§ 371 Date: Apr. 7, 2022

(30) Foreign Application Priority Data
Oct. 8, 2019 (KR) 10-2019-0124315

(51) Int. Cl. G06Q 30/06; G06F 16/583; G06F 16/538

(52) U.S. Cl. CPC G06Q 30/0631; G06F 16/583; G06F 16/538

(57) ABSTRACT

A service server includes a product database configured to extract a label describing product details, map the label to a product, and store the label; a query processing unit configured to receive a query to request recommended product information related to a search target object from a user device, recognize the search target object from the received query, and obtain a query label from the recognized search target object; a feature label list providing unit configured to search the product database for one or more candidate recommended products, generate a feature label list based on feature labels selected among feature labels tagged on the one or more candidate recommended products, and provide the feature label list to the user device; and a product recommendation module configured to search the product database for a recommended product, and provide the recommended product information to the user device.

### CROSS REFERENCE TO RELATED APPLICATIONS

This application is a National Stage of International Application No. PCT/KR2020/013651 filed Oct. 7, 2020, claiming priority based on Korean Patent Application No. 10-2019-0124315 filed Oct. 8, 2019.

### TECHNICAL FIELD

The present invention relates to a method for recommending a fashion product. More specifically, the present invention relates to a fashion product recommendation system that provides a user with information on a fashion product including a selection feature label selected by the user.

### BACKGROUND ART

With the growth of the wired and wireless Internet environment, commerce such as promotions and sales that happen online have become more active. In this regard, when purchasers find products they like while searching magazines, blogs, videos from YouTube, or the like on desktops or mobile devices connected to the Internet, the purchasers search for product names and the like, and purchase the products. For example, the name of a bag that a famous actress has carried at an airport or the name of a childcare product shown on a variety show may rise to the top of real-time search term rankings on portal sites. In this case, however, users need to separately open search web pages to search for product names, manufacturers, vendors, and the like, and have the inconvenience of not being able to easily search for the product names, the manufacturers, the vendors, and the like unless they already know definitive information on the product names, the manufacturers, the vendors, and the like.

Meanwhile, sellers spend much money on media sponsorship, online comment recruitment, and the like in addition to commercial advertisements to promote their products. This is because word of mouth online has recently acted as an important variable in product sales. However, it is often not possible to share shopping information, such as product names and vendors, even while these promotion costs are being spent. This is because it is not possible to individually obtain prior approval from media viewers for exposure to product names, and therefore advertising issues may arise.

As such, users and sellers need shopping information to be provided in a more intuitive user interface (UI) environment for online product images.

### DISCLOSURE OF INVENTION

### Technical Problem

The present invention is directed to providing a method, apparatus, and computer program for recommending a fashion product having improved search quality.

### Technical Solution

One aspect of the present invention provides a service server including: a product database configured to extract, for a product purchasable at an online market, a label which describes product details based on an image of the product, map the extracted label to the product, and store the extracted label; a query processing unit configured to receive, upon selecting a search icon from a user device displaying a screen including a search target object and a search icon displayed around the search target object, a query to request recommended product information related to the search target object from the user device, recognize the search target object from the received query, and obtain a query label from the recognized search target object; a feature label list providing unit configured to search, upon receiving the query label from the query processing unit, the product database for one or more candidate recommended products which are products tagged with the query label, generate a feature label list based on feature labels selected among feature labels tagged on the one or more candidate recommended products, and provide the feature label list to the user device; and a product recommendation module configured to search the product database for a recommended product including a selection feature label, which is a feature label selected by a user from the feature label list and the query label, and provide the recommended product information, which is information on the recommended product, to the user device, in which the feature label list provided to the user device is displayed around the search icon.

### Advantageous Effects

According to the present invention, it is possible to provide a method, apparatus, and computer program for recommending a fashion product having improved search quality.

### DESCRIPTION OF DRAWINGS

FIG. 1 is a diagram for describing a fashion product recommendation system according to an embodiment of the present invention.

FIG. 2 is a device diagram for describing an operation of the fashion product recommendation system of FIG. 1.

FIG. 3 is a diagram illustrating a user device provided with a feature label list according to an embodiment of the present invention.

FIG. 4 is a diagram illustrating an example of a user device on which recommended product information is displayed according to an embodiment of FIG. 3.

FIG. 5 is a diagram illustrating an example of a user device on which coordinated recommended product information is displayed according to the embodiment of FIG. 3.

FIG. 6 is a diagram for describing feature label information stored in a product database.

FIG. 7 is a flowchart for describing a method of recommending a fashion product according to an embodiment of the present invention.

FIG. 8 is a flowchart for describing the generation of the product database of FIG. 7.

FIG. 9 is a flowchart for describing the generation of a style database of FIG. 7.

### MODES OF THE INVENTION

Specific structural or functional descriptions of the embodiments according to the concept of the present invention disclosed in the present specification or application are merely exemplified for the purpose of describing the embodiments according to the concept of the present invention. Embodiments according to the concept of the present invention may be implemented in various forms, and should not be construed as being limited to the embodiments described in the present specification or application.

Since the embodiments according to the concept of the present invention may have various changes and may have various forms, specific embodiments will be illustrated in the drawings and described in detail in the present specification or application. However, it is to be understood that the present invention is not limited to a specific exemplary embodiment, but should be construed as including all modifications, equivalents, and substitutions without departing from the scope and spirit of the present invention.

Terms such as “first,” “second,” etc., may be used to describe various components, but the components are not to be construed as being limited by the terms. The terms are used only to distinguish one component from another component. For example, a first component could be called a second component and a second component could also be called a first component without departing from the scope of the present invention.

It is to be understood that when one element is referred to as being “connected to” or “coupled to” another element, it may be connected directly to or coupled directly to another element, or it may be connected to or coupled to another element with still another element intervening therebetween. On the other hand, it should be understood that when one element is referred to as being “connected directly to” or “coupled directly to” another element, it is connected to or coupled to another element with no other element interposed therebetween. Other expressions describing relationships between components, such as “between,” “directly between,” “neighboring,” “directly neighboring,” and the like should be similarly interpreted.

The terms used in the present specification are only used to describe specific embodiments, and are not intended to limit the present invention. Singular forms are intended to include plural forms unless the context clearly indicates otherwise. It will be further understood that the terms “comprise” or “have” used in this specification specify the presence of stated features, steps, operations, components, parts, or combinations thereof, but do not preclude the presence or addition of one or more other features, numerals, steps, operations, components, parts, or combinations thereof.

Unless indicated otherwise, it is to be understood that all terms used in this specification including technical and scientific terms have the same meanings as those that are generally understood by those skilled in the art. Terms such as those defined in commonly used dictionaries should be interpreted as having meanings consistent with the context of the related art, and should not be interpreted in an ideal or excessively formal sense unless explicitly so defined in the present specification.

In describing the embodiments, description of technical content that is well known in the technical field to which the present invention belongs and not directly related to the present invention will be omitted. This is to more clearly convey the gist of the present invention without ambiguity by omitting unnecessary explanations.

Hereinafter, by describing exemplary embodiments of the present invention with reference to the accompanying drawings, the present invention will be described in detail. Hereinafter, embodiments of the present invention will be described with reference to the accompanying drawings.

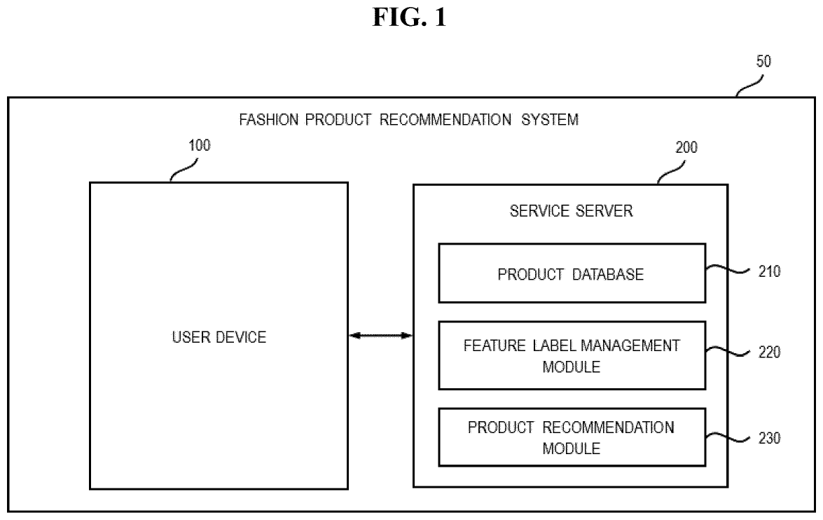

FIG. 1 is a diagram for describing a fashion product recommendation system according to an embodiment of the present invention.

Referring to FIG. 1, a fashion product recommendation system 50 may include a user device 100 and a service server 200.

According to an embodiment of the present invention, the fashion product recommendation system 50 may have improved search quality by providing information on a product with high relevance to a query without separate entry of a search word. In addition, the fashion product recommendation system 50 of the present invention may provide a wider range of product information that a user does not even think of by providing additional product information related to the query.

The query may include a series of actions in which the user device 100 requests recommended product information from the service server 200. The query may include not only keywords of a specific product or style, but also images such as photos and captured screens. According to an embodiment, the query may include various forms such as voice, video, and a Uniform Resource Locator (URL) included in a web page. The query image may be a query provided in the form of an image.

The label may express information describing product details in the form of a vector based on an image of a product. In addition, the label may express, in the form of a vector, information describing a feeling that a human may intuit from a style image in which a person is wearing a plurality of fashion items. A feature label may express, in the form of a vector, a feeling that a human may intuit from the image of the product, and attribute information such as a material and use of the product, and the like.

The query label may be a label extracted from the query. For example, the user may request a search by taking a photo of a jacket on a screen while viewing a website. The service server 200 may recognize a fashion item object, that is, the jacket, from the received query, and processes the jacket image to extract a label (query label) describing a category, a color, a material, a style, etc., of the corresponding item based on the image.

A product retrieved as a product including a query label in the product database 210 may be a recommendation target product. All feature labels included in recommended target products may constitute a feature label list.

According to an embodiment, the feature label list may be generated according to the number of times each feature label is counted. A product including a feature label selected by a user among the recommended target products may be determined as a recommended product thereafter.

The feature label list may be a list stored in the form of a lookup table in which fashion products are mapped with keywords indicating characteristics of the corresponding product. A user may search for products by using the keywords provided in the feature label list.

The selected feature label may be a label selected by a user for feature labels provided as the feature label list. Since the feature label list includes various feature labels that indicate features of fashion products, such as the category, color, material, and style of the query, the user may select his/her favorite feature label from these feature labels.

Thereafter, the product including the selected feature label may be searched for in a product database 2W, and information on the retrieved product (recommended product) may be provided to the user as recommended product information.

In an embodiment, the feature label list may include all the feature labels included in products corresponding to the query label (all products belonging to the jacket category in the above example). For example, when a jacket query is input, the service server 200 may generate a feature label list based on all the feature labels (leather label, overfit label, black label, casual label, hood label, etc.) extracted from the image of the jacket product.

In another embodiment, the feature label list may include the preset number of feature labels in the order of the highest increase rate of the counted number for a certain period of time among all the feature labels included in the products corresponding to the query.

In another embodiment, the feature label list may include feature label lists sorted in order from the highest increase rate of the counted number for a certain period of time among all the feature labels included in the products corresponding to the query.

The reason for providing a certain period of time may be because, as the period for which a specific product is registered and exposed or retrieved increases, the accumulated amount of count information for the corresponding product increases in proportion to the period, and thus an error factor may be effectively removed.

For the feature label included in the feature label list, when the user selects the feature label, the corresponding feature label may be counted. In addition, when the recommended product can be retrieved with the remaining feature labels other than the feature label of the feature label list, these feature labels may also be counted together.

The count information may include a counted number for each feature label. The counted number may be independently counted for each feature label and may be mapped to a product corresponding to the feature label and stored in the product database 2W together.

In the example of the jacket above, the leather label, the overfit label, the black label, the casual label, and the hood label constitute the feature label list and may be provided to the user. The user may select the leather label in response thereto. In this case, the service server 200 may increase the counted number of the leather label by 1 and store the leather label in the product database 2W.

Thereafter, the service server 200 may search the product database 210 for the selected feature label and confirm other feature labels tagged with the selected feature label in the retrieved products (recommended products).

The service server 200 may increase the counted number of the feature label different from the selected feature label by 1, except for feature labels previously provided in a feature label list among the other feature labels.

In the example of the jacket above, the user may exemplify a case in which the leather label is selected as the selected feature label among the feature labels provided in the feature label list. The service server 200 may determine, as the recommended products, products including the leather label among products belonging to the jacket category (leather jackets).

The leather jackets determined as the recommended products may be tagged with not only the leather label and the jacket label, but also other characteristic labels expressing the features of each leather jacket.

These feature labels may be feature labels that are provided in the feature label list but not selected by the user, or feature labels not included in the feature label list from the beginning.

When the recommended product is determined according to the user's selection of the selected feature label, the service server 200 may increase the counted number of the feature label that was not included in the feature label list from the beginning among the feature labels tagged in the recommended product by 1.

The recommended product may be determined by searching the product database 210 for the feature label included in the feature label list, but since the recommended product may include other feature labels, it is difficult to confirm these feature labels using only the feature label list.

Also, although the feature label is not a feature label selected by the user directly reflecting his or her taste, the feature label may be a feature label that is frequently tagged together with the selected feature label reflecting the user's taste, and as a result, may be a feature label that unconsciously reflects the user's preference.

The service server 200 may count the selected feature label selected by the user from the feature label list, and at the same time, count feature labels different from the selected feature label tagged on the recommended product, thereby more accurately reflecting a user's needs when the feature label list is provided to the user.

According to an embodiment of the present invention, the service server 200 may also count feature labels that frequently appear together with the selected feature label reflecting the user's taste, and then reflect the counted feature labels in the feature label list. In this way, it is possible to increase the accuracy of the search through a secondary query called the feature label list to the user, and increase search quality by reflecting not only the selected feature label directly selected by the user but also the feature label information that appears frequently therewith.

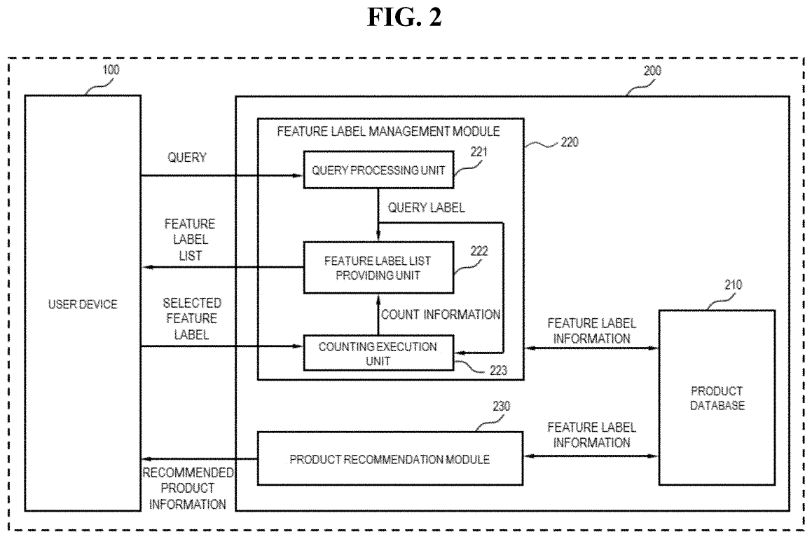

FIG. 2 is a device diagram for describing an operation of the fashion product recommendation system of FIG. 1.

Referring to FIG. 2, the fashion product recommendation system 50 may include the user device 100 and the service server 200.

The concept of the user device 100 may include any type of electronic device capable of requesting a search and displaying advertisement information, such as a desktop, a smart phone, and a tablet personal computer (PC).

In the user device 100, the user may view a web page, a style book, or the like, and request information on a product or style from the service server 200. A user who is viewing a web page or an arbitrary image may provide, to the service server 200, a query about product information on a specific fashion product.

For example, the user may provide a query requesting information on a specific fashion product to the service server 200 while viewing an arbitrary shopping mall. According to an embodiment, the user may take a photo of a specific style image offline and provide a query requesting information on the corresponding style image to the service server 200.

In the user device 100, the user may view the style book provided through an application according to the embodiment of the present invention. In this case, the user device 100 may provide a query requesting information on a specific style image included in the style book to the service server 200.

The user device 100 that transmits the query may transmit a query including a history log of a web browser to the service server 200. The history log may include a browsing execution history of the web browser and URL information of the web page executed at that time. Furthermore, the user device 100 may extract an image, video, and text data included in a URL of the web page, and transmit the extracted data as a query. Furthermore, when the URL, the text, the image, or the video data cannot be extracted, screenshots may be extracted and transmitted as a query.

In particular, the user device 100 according to the exemplary embodiment of the present invention may transmit the image displayed at that time as a query. For example, the user device 100 may extract a searchable object from the image included in the style book received from the service server 200 and transmit the extracted object as a query.

The user device 100 may transmit a query even when a user does not request a separate search, but may also transmit the query based on a user search request as a condition.

For example, the user device 100 may transmit a query on the condition that a user's search request is received. When the user inquires about an upper attribute label for a fashion product included in the image being viewed, the user device 100 may extract an object in the image for which the search request has been received and transmit the extracted object as a query. Alternatively, the user device 100 may specify the searchable object in the displayed image in advance and transmit a query for the object for which the user selection input has been received.

To this end, the user device 100 may perform an operation of first determining whether an object of a preset category is included in the displayed image, specifying the object, and displaying a search request icon for the object.

According to the above embodiment, the user device may perform an operation of specifying an object for a fashion item in the image included in the style book and transmitting only a query for the specified object. Furthermore, when the image includes objects for a plurality of fashion products, the user device may perform an operation of specifying each object and transmitting only the query for the object selected by the user.

The service server 200 may include the product database 2W, a feature label management module 220, and a product recommendation module 230.

The product database 2W may store feature label information. The feature label information may include information in which a feature label describing product details based on an image of a product is tagged on a product purchasable at an online market.

The feature label information may include detailed product information such as a country of origin, a size, a vendor, and a wearing shot of products sold at the online market. The detailed product information may include information (image data or an image address) from which an image may be extracted, and may also include text information describing the product.

The product database 2W may extract a feature label that may characterize each product based on the image and text of the product collected online, map the feature label with the corresponding product, and store the feature label in the product database 2W.

Thereafter, when the query is input from the user device 100, a candidate recommended product including the query label may be searched for in the product database 210, and a feature label list may be generated based on the feature labels tagged on the candidate recommended product. Thereafter, when determining the recommended product according to the selected feature label received from the user device 100, it may be used to search for the recommended product including the selected feature label.

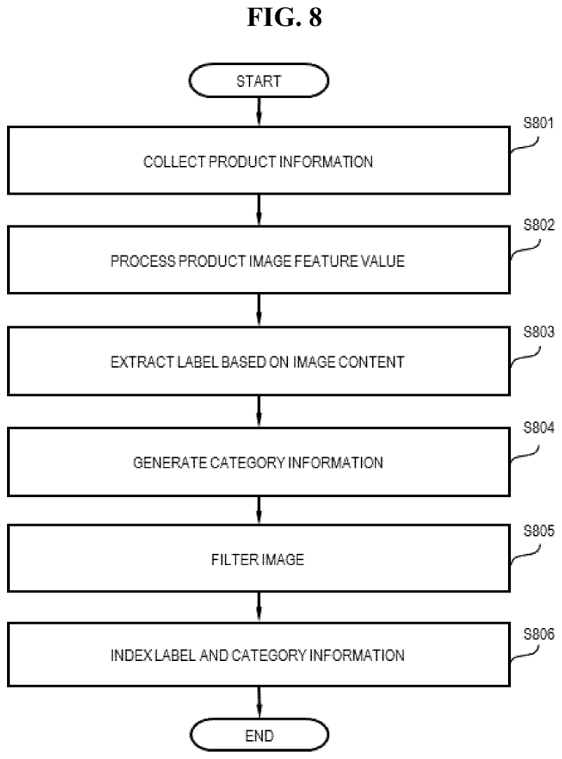

A detailed description of generating the product database 210 according to the embodiment of the present invention will be described below along with the description of the accompanying drawing of FIG. 8.

The feature label management module 220 may include a query processing unit 221, a feature label list providing unit 222, and a counting execution unit 223.

The query processing unit 221 may receive a query, recognize a fashion item object from the received query, process an image, and extract a query label describing a category, a color, a material, a style, etc., of the corresponding item based on the image.

To this end, the query processing unit 221 may extract a feature of a search target image object and structure feature information of the images for efficiency of the search. A more detailed method may be understood with reference to a product image processing method to be described below in the description of FIG. 8.

In another embodiment, the query processing unit 221 may directly receive a word representing a feature label from a user in addition to the image. When the user inputs “guest look,” the query processing unit 221 may extract a guest look or a label similar to the guest look as a query label.

Furthermore, the query processing unit 221 according to the embodiment of the present invention may apply, to the processed search target object image, a machine learning technique used to generate a product database 210 to be described below in the description of FIG. 8, thereby extracting the label and/or category information on the meaning of the search target object image. The label may be expressed as an abstracted value, or may also be expressed in text form by interpreting the abstracted value.

Specifically, the query processing unit 221 may generate a query label using machine learning based on a recurrent neural network (RNN). Machine learning is one field of artificial intelligence and can be defined as systems for performing learning based on empirical data, making predictions, and improving their own performance, and sets of algorithms for such systems. A model used by the query processing unit 221 may use any one of a model-centric deep neural network (DNN) of machine learning, a convolutional deep neural network (CNN), a recurrent artificial neural network (RNN), and a deep belief network (DBN).

For example, the query processing unit 221 according to the embodiment of the present invention may extract query labels for women, dresses, sleeveless, linen, white, and casual looks from the query image. In this case, the query processing unit 221 may use labels for women and dresses as the category information of the query image, and use labels for sleeveless, linen, white, and casual looks as labels describing characteristics of the query image other than the category.

In the embodiment, the query processing unit 221 may receive, as a query, user IDs assigned to each user from the user device 100 or the service server 200, and search a user database for preference labels reflecting a user's taste for fashion products matched with each user ID.

In this case, upon receiving a preference label from the query processing unit 221, the product recommendation module 230 may determine a product tagged with the preference label as a recommended product and provide the determined product to the user device 100.

Upon receiving at least one preference label from the query processing unit 221, the feature label list providing unit 222 may refer to the user database to sort the preference labels according to the user's preference and provide the sorted preference labels as a list.

The feature label list providing unit 222 may generate the feature label list based on the query label received from the query processing unit 221 and provide the generated feature label list to the user device 100.

Specifically, upon receiving the query label from the query processing unit 221, the feature label list providing unit 222 may search the product database 210, determine a candidate recommended product which is a product tagged with the query label, generate a feature label list based on the feature label tagged on the candidate recommended product, and provide the generated feature label list to the user device 100.

In an embodiment of the present invention, the product database 210 may be used to search for products including a query label. That is, the product database 2W may be used to search for the candidate recommended product for determining the feature label list.

The product database 210 may store product information tagged with feature labels predefined through a neural network model. The feature label list providing unit 222 may compare the query label received from the query processing unit 221 with the feature label tagged in the product information stored in the product database 2W to determine, as the candidate recommended product for generating the feature label list, the product tagged with the query label.

For example, when the query label is a jacket label, the feature label list providing unit 222 may search the product database 2W for a product tagged with the jacket label. The retrieved target products may be the candidate recommended product. The product database 2W may provide, as a feature label list, information on feature labels tagged with the candidate recommended product to the feature label list providing unit 222.

The feature label list providing unit 222 may receive the feature label information from the product database 210 and refer to the count information to generate the feature label list.

The feature label list may be a list stored in the form of a lookup table in which fashion products are mapped with keywords indicating characteristics of the corresponding product. A user may search for products by using the keywords provided in the feature label list.

The feature label list may include all the feature labels included in the candidate recommended products. For example, when a jacket query is input, the feature label list generation unit 222 may generate a feature label list including all the feature labels (leather label, overfit label, black label, casual label, hood label, etc.) extracted from the jacket.

In an embodiment, the feature label list may include the preset number of feature labels in order from the highest increase rate of the counted number for a certain period of time among all the feature labels included in the candidate recommended products. In another embodiment, the feature label list may be included by sorting the feature label lists in order from the highest increase rate of the counted number among all the feature labels included in the candidate recommended products.

The feature label list providing unit 222 may provide the generated feature label list to the user device 100, and the user device 100 may select a favorite feature label among the feature labels included in the feature label list. The feature label selected by the user may be a selected feature label.

The counting execution unit 223 may generate count information and provide the generated count information to the feature label list providing unit 222.

The count information may include the counted number for each feature label. The counted number may be independently counted for each feature label and may be mapped to a product corresponding to the feature label and stored in the product database 2W.

For the feature label included in the feature label list, when the user selects the feature label, the corresponding feature label may be counted. In addition, when the recommended product can be retrieved with the remaining feature labels other than the feature label of the feature label list, these feature labels may also be counted together.

When the feature label list is generated based on the count information, the feature label list reflecting the user's taste may be provided. The count information may be information in which the user's taste and preference are weighted in the form of the counted number. A higher increase rate of the counted number may be determined to indicate that the user has a higher interest in the product.

Therefore, the feature label list providing unit 222 may generate, as the feature label list, the preset number of feature labels of which the increase rate of the counted number is higher than a specific value in order, or sort all feature labels having an increase rate higher than a specific value in descending order to generate the sorted feature labels as the feature label list.

The product recommendation module 230 may search the product database 2W for a selected feature label for which a search is requested by a keyword in the feature label list, and may provide the retrieved recommended product information to a user.

Specifically, a product including the selected feature label and the query label which is a label selected by the user for the feature label list may be searched for in the product database 210, and the recommended product information which is information on the recommended product, that is, the retrieved product, may be provided to the user device 100.

The product recommendation module 230 may refer to the feature label information stored in the product database 2W to search for the product including the selected feature label.

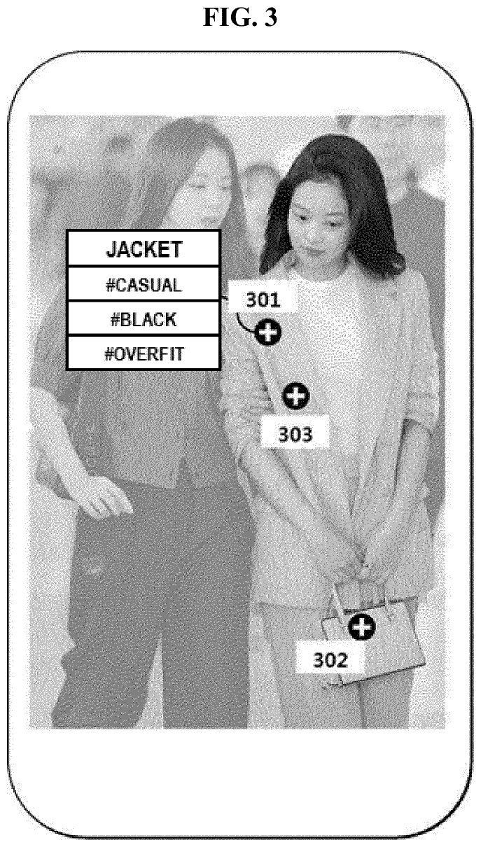

FIG. 3 is a diagram illustrating the user device 100 provided with a feature label list according to an embodiment of the present invention.

Referring to FIG. 3, the user device 100 may provide, to the service server, a query about information on a product or style image worn by a celebrity on a web page being viewed.

The query may include label information on a product such as a jacket or handbag worn by a celebrity. In addition, style label information on style images such as celebrity look, magazine look, summer look, feminine look, sexy look, office look, drama look, and Chanel look derived from a plurality of fashion items worn by a celebrity may be included.

The label may be understood as identifying which classification information a search target query has by using a model trained using machine learning. The service server 200 may use a label (classification information) or image feature information of the search target product or style to search for product-related information having the same or similar label or similar style image feature information in a product database or a style database.

FIG. 3 illustrates that a query is provided as a celebrity image of a web page, but the query may be provided in various ways, such as text, video, a URL of a web page, or voice, according to an embodiment.

The search icon may provide a function of displaying a feature label list or displaying a related URL link.

The user device 100 may display search icons such as 301, 302, and 303 on the screen of the user device 100. When a user transmits a query to the service server 200 by hovering a mouse cursor over the search icon, clicking the search icon, or the like, the user may view a feature label list of an object corresponding to the search icon.

In FIG. 3, a user may inquire of the service server 200 about an object corresponding to a search icon 301. The service server 200 may confirm the pre-tagged feature label on the product worn by the celebrity, or when there is no tagged label, process the query image to extract the feature label.

The service server 200 may extract a query label corresponding to a jacket label from the query corresponding to the search icon 301. The service server 200 may search for products including the jacket label in the product database and determine the retrieved products as candidate recommended products.

The service server 200 may confirm different feature labels tagged on the candidate recommended products. All of these feature labels may constitute a feature label list to be provided as a questionnaire for finding out a user's taste. However, when the entire feature label is included in the feature label list, it may be difficult to fully reflect the user's taste. Accordingly, the service server 200 of the present invention may generate the feature label list using the count information.

The count information may be the increased counted number of the selected feature label whenever the user selects the selected feature label for the feature label list previously provided to the user. The counted number may be independently counted for each feature label, and the counted number for each feature label may be mapped to the corresponding product, and both of the counted number and the corresponding product may be stored in the product database.

Also, the count information may be the number of times a feature label included in a recommended product among the feature labels not included in the feature label list is counted every time the selected feature label is selected.

When the feature label list is generated based on the count information, the feature label list reflecting the user's taste may be provided. The count information may be information in which the user's taste and preference are weighted in the form of the counted number. A higher increase rate of the counted number may be determined to indicate that the user has a higher interest in the product.

Therefore, the feature label list providing unit 222 may generate, as the feature label list, the preset number of feature labels of which the increase rate of the counted number is higher than a specific value in order, or sort all the feature labels having an increase rate higher than a specific value in descending order to generate the sorted feature labels as the feature label list.

FIG. 3 illustrates that, when the user clicks the search icon 301, the preset number of (three) feature labels (casual label, black label, and overfit label) are provided as the feature label list.

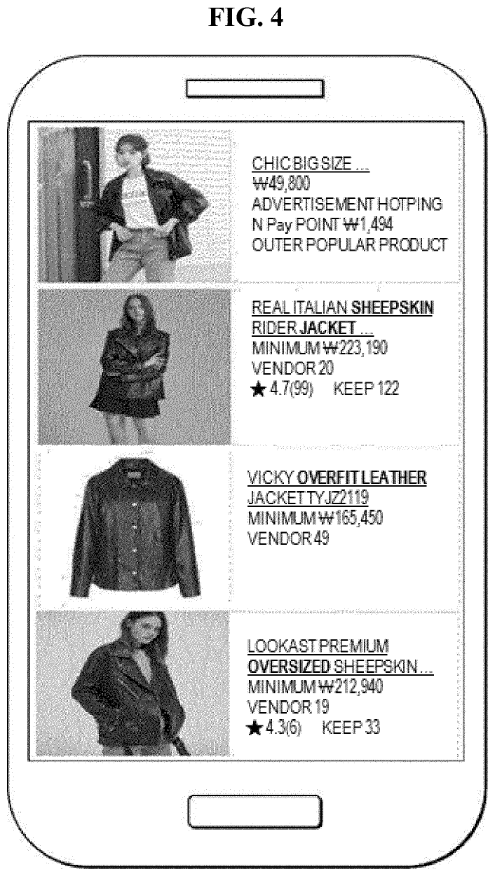

FIG. 4, which will be described below, illustrates recommended product information displayed on the user device 100 when a user selects a black label and an overfit label among the above feature labels.

Similarly, the user may inquire of the service server about the object corresponding to a search icon 302.

The service server 200 may extract a query label corresponding to a handbag label from the query corresponding to the search icon 302. The service server 200 may extract the query label by processing the query image when a product worn by a celebrity does not have a pre-tagged label.

Thereafter, the service server 200 may search for products including the handbag label in the product database and determine the retrieved products as the candidate recommended products.

FIG. 3 illustrates that, when the user clicks the search icon 302, the preset number of (three) feature labels (shoulder bag label, leather label, and stripe label) are provided as the feature label list.

A search icon 303 shows requesting a style image with a query. The user may inquire of the service server 200 about the object corresponding to the search icon 303. In this case, an object may be a style image which is an overall impression or feeling that general people may have when a plurality of fashion items called celebrity look are combined.

The service server 200 may extract a celebrity look label from the query corresponding to the search icon 303. The service server 200 may extract a label by processing the query image when a product worn by a celebrity does not have a pre-tagged label. Thereafter, the service server may search for products including the “celebrity look label” in the product database and determine the retrieved products as the candidate recommended products.

FIG. 3 illustrates that, when the user clicks the search icon 303, the preset number of (three) feature labels (trend label, exposure label, and airport fashion label) are provided as the feature label list.

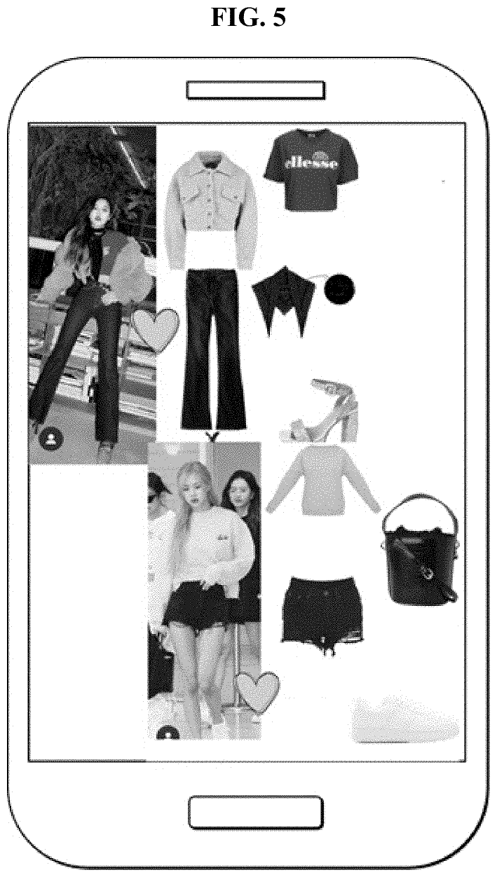

When the recommended product is determined through the style image, the user may view the style image in which the fashion item including the query label and the selected feature label is coordinated. FIG. 5, which will be described below, illustrates recommended product information and coordination information displayed on the user device 100 when the user selects the trend label.

When the trend label is selected, a user may be provided with the recommended product determined by reflecting trend information that comprehensively considers the number of product hits on a website upon searching for the product, a period of a trend, a frequency of appearance on the website for a certain period of time, or the like.

FIG. 4 is a diagram illustrating the user device 100 on which recommended product information is displayed according to an embodiment of FIG. 3.

Referring to FIG. 4, the service server 200 may provide customized recommended product information according to the user's selection of the selected feature label. As described above in FIG. 3, a user may select, as the selected feature label, a black label and an overfit label from among the casual label, the black label, and the overfit label.

The service server 200 may search the product database for products including all of the jacket label, which is the query label, the black label, which is the selected feature label, and the overfit label.

The retrieved product may be the recommended product. Detailed product information such as a brand, a price, a vendor, and reviews of other users of the recommended product may be provided to a user. FIG. 4 illustrates that product information on “a jacket made of a black leather material” is displayed on the user device 100 when a user selects a leather label and a black label as an upper attribute label.

According to an additional embodiment of the present invention, a user preference label may be used to provide user-customized recommended product information. For example, when the user selects an arbitrary feature label as a query, the service server 200 may provide a product matching the user preference label among products including the selected feature label to the user device 100 with high priority. As another example, when the user inputs a keyword for an arbitrary exhibition, the service server 200 may provide the user device 100 with products matching the user preference label among products included in the exhibition with high priority.

FIG. 5 is a diagram illustrating the user device 100 on which coordinated recommended product information is displayed according to the embodiment of FIG. 3.

Referring to FIG. 5, the service server 200 may provide style information in which the recommended products are coordinated according to the user's selection of the selected feature label. As described above in FIG. 3, when a user requests a query for a celebrity look, the service server 200 may search the product database and query the user to select a selected feature label.

FIG. 5 illustrates recommended product information displayed on the user device 100 when the user selects the trend label as the selected feature label. Compared to the case of FIG. 4, in the embodiment of FIG. 5, a user may be provided with not only simple product details, but also style information in which the recommended product is coordinated. That is, a user may be provided with the style information combined with the fashion products including both the query label and the selected feature label.

FIG. 5 illustrates a case in which the trend label is selected in response to a query to select the upper attribute label of the service server 200. The service server 200 may search the product database for the style information coordinated as the fashion product including the celebrity look label and the trend label. In addition, information on the brand, price, country of origin, material, and category product itself of each product used for coordination may be confirmed through the product database search.

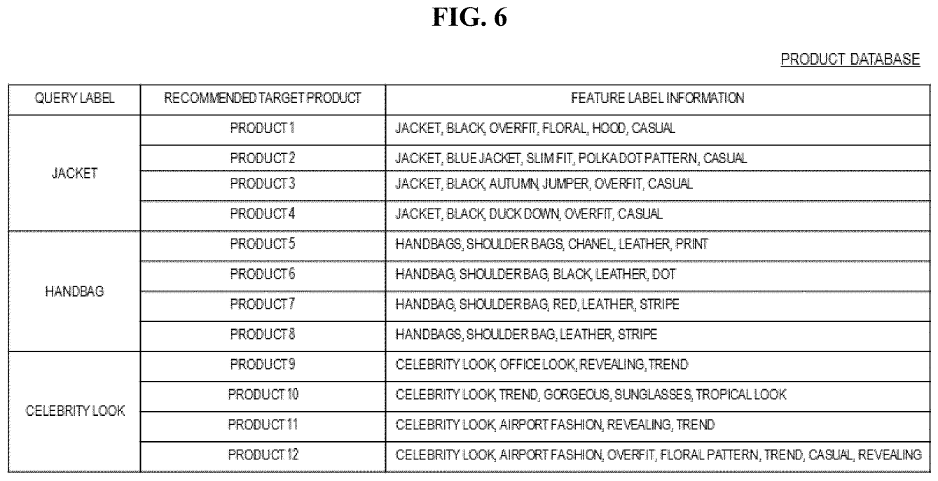

FIG. 6 is a diagram for describing feature label information stored in a product database.

Referring to FIG. 6, the service server 200 may first search the product database for products including a query label.

The retrieved products are candidate recommended products, and may be candidate product groups that may become recommended products according to a selected feature label to be determined through a query between the user and the service server 200.

The service server 200 may generate a feature label list based on labels tagged on the candidate recommended products. The service server 200 may confirm the feature labels tagged on the candidate recommended products, and confirm count information of each feature label.

Thereafter, the service server 200 may generate a feature label list with the preset number of feature labels in order from the highest increase rate of the counted number.

According to an embodiment, the feature label list may be generated by sorting, in descending order, all the feature labels included in the candidate recommended products in order from the highest increase rate of the counted number.

Also, according to an embodiment, all the feature labels included in the candidate recommended products may be generated as the feature label list.

Even when the label is included in the candidate recommended products, a feature label with a low increase rate of the counted number may have relatively low importance or is likely to be a feature label that a user does not want to search with.

For example, product 1 of FIG. 6 may include a floral label. Compared to features that may be frequently combined with a jacket like “a jacket in black that gives a casual feeling,” the floral jacket may give general consumers a distinct feeling of individuality.

The service server 200 may determine the feature label included relatively more in the candidate recommended product as a feature of a fashion product that more consumers want to search for, excluding the floral jacket where a difference in individual taste may be relatively large.

Referring to FIG. 6, the label extracted from the query image may be the jacket label. In this case, the service server 200 may search the product database for products including the jacket label and determine products 1 to 4 as candidate recommended products.

Referring to the feature label information of products 1 to 4, the candidate recommended products include four jacket labels, four casual labels, three black labels, two overfit labels, and one other label each. For convenience of explanation, a higher number of included feature labels is assumed to indicate a higher increase rate of the counted number of feature labels.

Except for the labels extracted from the query image, when the labels are sorted in descending order of the counted number, the labels may be casual labels, black labels, overfit labels, and other labels.

According to an embodiment, all of the feature labels sorted in descending order may be included in the feature label list.

However, when the number of recommended upper attribute labels is previously determined to be three, the service server 200 may include only three upper counted labels in the feature label list. In this case, the feature label list may include the casual label, the black label, and the overfit label.

Referring back to FIG. 6, even when the label extracted from the query image is a handbag, the shoulder bag label, the leather label, and the stripe label may be determined as the feature label list according to the above-described process.

Similarly, when the label extracted from the query image is a celebrity look, the trend label, the exposure label, and the airport fashion label may be determined as the feature label list according to the above-described process.

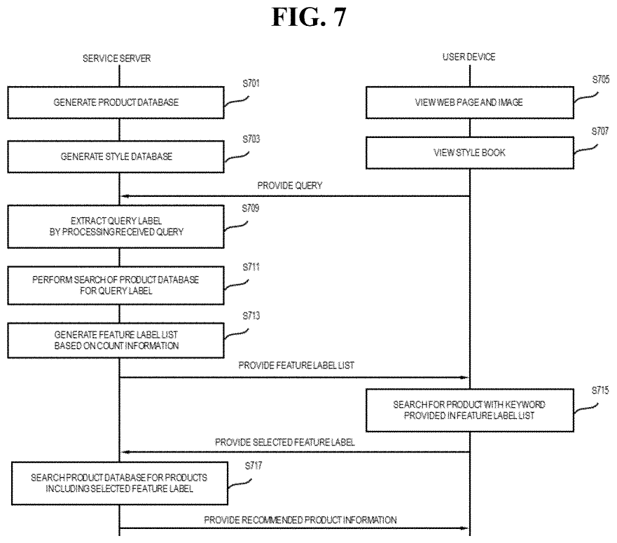

FIG. 7 is a flowchart for describing a method of recommending a fashion product according to an embodiment of the present invention.

Referring to FIG. 7, in operations S701 and S703, the service server 200 according to the embodiment of the present invention may generate a database that is a basis for product recommendation. The database may include the product database and the style database. The service server 200 may perform a function of searching for a query by referring to the product database and the style database and determining a recommended product.

The product database may include detailed product information such as the country of origin, size, vendor, and wearing shot of products sold at the online market. The style database may include information on a fashion image that may refer to a fashion style and coordination of a plurality of items among images collected on a web.

In particular, the product database according to the embodiment of the present invention may configure product information based on the image of the product (operation S701). A detailed description of generating a product database according to the embodiment of the present invention will be described below with reference to FIG. 8.

Meanwhile, the service server 200 according to the embodiment of the present invention may generate the style database that is the basis of the style recommendation (operation S703).

The style database may include, among the images collected online, an image (referred to as a style image in this specification) in which a plurality of fashion items are combined to fit well and classification information on the style image. The style image according to the embodiment of the present invention is image data generated by allowing experts or semi-professionals to combine a plurality of fashion items in advance, and examples of the style image may include fashion catalogs that may be collected on a web, fashion magazine pictorial images, fashion show shooting images, idol costume images, costume images from certain dramas or movies, costume images of SNS and blog celebrities, street fashion images from fashion magazines, images coordinated with other items for a sale of fashion items, etc.

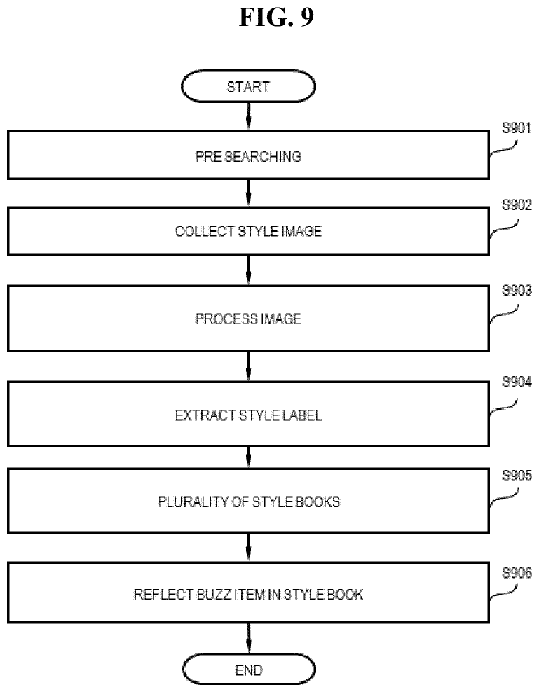

A method of generating a style database according to an embodiment of the present invention will be described below with reference to FIG. 9.

In operation S705, a user who is viewing a web page or any image may inquire of the service server 200 about a query on product information on a specific fashion product or a query to request a feature label list of the fashion product.

For example, a user may request information on a specific fashion product while browsing an arbitrary shopping mall, or inquire of the service server 200 about a query to request a feature label list including feature labels selected according to the count information among the feature labels included in products of the same category as the specific fashion product.

According to an embodiment, a user may take a picture of a specific style image offline to request information on the corresponding style image or inquire of the service server 200 about the query to request the feature label list including the feature label selected according to the count information among the feature labels included in the photographed style image.

In operation S707, the user device 100 may view the style book provided through an application according to the embodiment of the present invention. In this case, the user device 100 may request the information on the specific style image included in the style book or inquire of the service server 200 about the query to request the feature label list including the feature label selected according to the count information among the feature labels of the specific style image.

The user device 100 transmitting the query may transmit, for example, a query including a history log of a web browser to the service server 200. The history log may include a browsing execution history of the web browser and URL information of the web page executed at that time. Furthermore, the user device 100 may extract an image, video, and text data included in the URL of the web page, and transmit the extracted data as a query. Furthermore, when the URL, the text, the image, or the video data cannot be extracted, screenshots may be extracted and transmitted as a query.

Meanwhile, in operation S709, the service server 200 according to the embodiment of the present invention may process the received query. This may be to search the product database for a product including a label extracted based on the content of the query.

Hereinafter, it is assumed that the query requested by the user is a query image which is a query in the form of an image. However, according to the embodiment, the query may include not only an image but also voice, a URL of a web page, text, a video, and the like.

The service server 200 according to the embodiment of the present invention may receive a query image, and when a plurality of objects are included in the query image, the objects are separated and are each recognized. In the query received by the user device 100, a search target object may be specified.

To this end, the service server 200 may extract features of the image object to be searched for and structure the feature information of the images for the efficiency of the search. A more detailed method may be understood with reference to a product image processing method to be described below in the description of FIG. 8.

Furthermore, the service server 200 according to the embodiment of the present invention may apply, to the processed search target object image, a machine learning technique used to generate a product database to be described below in the description of FIG. 8, thereby extracting the label and/or category information on the meaning of the search target object image. The label may be expressed as an abstracted value, or may be expressed in text form by interpreting the abstracted value.

For example, the service server 200 according to the embodiment of the present invention may extract labels for women, dresses, sleeveless, linen, white, and casual looks from the query image. In this case, the service server 200 may use labels for women and dresses as the category information of the query image, and use labels for sleeveless, linen, white, and casual looks as label information describing characteristics of the query image other than the category.

In operation S711, the service server 200 may perform the product database search for the label extracted from the query image. This may be for determining the product database for a recommended target product by searching for a product including the extracted label, and generating a feature label list from feature labels included in the recommended target product.

For example, when the handbag label is extracted from the query image, the service server 200 may search the product database for products including a handbag label in common. In this case, in order to increase the accuracy of the image search, the search may be performed in a way that excludes products that do not match the label of the query image.

Although not illustrated in the drawings, in another embodiment of the present invention, the service server may search the style database for the query label extracted from the query image.

In operation S713, the service server 200 may search the product database and/or the style database for products tagged with the query label to determine the recommended target product, and generate the feature label list based on the count information of different feature labels included in the recommended target products.

The feature label list may include all different feature labels, may include all feature labels sorted in descending order according to the count information, or may include only the preset number of feature labels in descending order of the counted number.

For example, when the query label is a handbag label, products including the handbag label in common may be searched for in the product database. The service server 200 may generate a feature label list by referring to feature label information which is information on labels such as a shoulder bag, leather, a cross bag, and an office look included in the retrieved products.

Also, the service server 200 may search the product database and/or the style database for the query label including the celebrity look label. The style database may include style images in which a person directly wears a plurality of fashion items. Accordingly, in some cases, the utilization may be higher than that of searching in the product database that stores product information in a single fashion item. That is, there is an advantage in that the utilization of the recommended product may increase compared to receiving the single fashion item recommendation.

The query image may be searched for only in the product database as in the embodiment of FIG. 7, or, although not illustrated in the drawings, may be searched for only in the style database. In addition, according to an embodiment, the query image may be searched for in both the product database and the style database.

Then, in operation S715, the user device 100 may search for a product with a keyword (selected feature label) provided in the feature label list.

The user may select at least one of his/her favorite feature labels from among the feature labels provided from the feature label list, and the selected feature label may be provided to the service server 200. The selected feature label may be a selected feature label.

For example, the user may receive a recommended upper attribute label corresponding to the pre-provided shoulder bag, leather, cross bag, and office look, and select the shoulder bag and leather labels as the selected feature label.

In operation S717, the service server 200 may search the product database for products including both the query label and the selected feature label.

For example, the query label may be a handbag label, and the selected feature label may be a shoulder bag or leather label. The service server 200 may search the product database for products including all of the handbag label, the shoulder bag label, and the leather label.

The service server 200 may generate the recommended product information which is information on a product including both the query label and the selected feature label. The generated recommended product information may be provided to the user device 100.

The method of recommending a fashion product according to the embodiment of the present invention may provide a related upper attribute label without a separate input of a related search word when a user inquires about information on a specific product. For example, when a user requests product information on a handbag included in a web page being viewed, the service server 200 may receive a feature label list on the handbag without a separate request from the user.

In addition, the fashion product recommendation system of the present invention may provide a wider range of product information that a user does not even think of by providing additional product information related to the query to the user.

FIG. 8 is a flowchart for describing the generation of the product database of FIG. 7.

Referring to FIG. 8, in operation S801 of FIG. 8, the service server 200 may collect product information.

The service server 200 may collect product information on products sold at any online market, as well as product information at a pre-affiliated online market. For example, the service server 200 may include a crawler, a parser, and an indexer to collect web documents of an online store and access text information such as product images, product names, and prices included in the web documents.

For example, the crawler may transmit data related to the product information to the service server 200 by collecting a list of web addresses for online stores, confirming websites, and tracking links. In this case, the parser may parse the web documents collected during the crawling process and extract product information such as product images, product prices, and product names included in the page, and the indexer may index the locations and meanings.

Meanwhile, the service server according to the present invention may collect and index product information from websites of any online store, or may receive product information in a preset format from an affiliate market.

In operation S802, the service server may process the product images. This is to determine the recommended item based on whether the product images are similar without relying on text information such as the product names or the sales categories.

According to an embodiment of the present invention, a recommended item may be determined based on whether the product images are similar, but the present invention is not limited thereto. That is, according to the implementation, the product images as well as the product names or the sales categories may be used as single or auxiliary queries. To this end, the service server may generate a database by structuring the text information such as the product names and the product categories in addition to the product images.

According to an exemplary embodiment of the present invention, the service server may extract the features of the product images, and structure (index) the feature information of the images for the efficiency of the search.

More specifically, the service server may detect (perform interest point detection on) a feature area of the product images. A feature area is a descriptor for a feature of an image for determining whether images are identical or similar, that is, a main area in which a feature descriptor is extracted.

According to an embodiment of the present invention, such a feature area may be a contour included in an image, edges such as corners among the contour, a blob that is distinguished from a surrounding area, an area that is invariant or co-variant according to the deformation of the image, or a pole that is characterized by being darker or brighter than the ambient light, and as a target of the feature area, there may be a patch (piece) of an image or the entire image.

Furthermore, the service server may extract a feature descriptor from the feature area. The feature descriptor expresses features of an image as vector values.

According to an embodiment of the present invention, such a feature descriptor may be calculated using a location of a feature region for the corresponding image, or brightness, color, sharpness, gradient, scale, or pattern information of the feature area. For example, the feature descriptor may convert a brightness value of a feature area, a change value or a distribution value of brightness, or the like into vectors and may be calculated.

Meanwhile, according to the embodiment of the present invention, the feature descriptor for the image may be expressed as not only a local descriptor based on the feature area as above, but also a global descriptor, a frequency descriptor, a binary descriptor, or a neural network descriptor.

More specifically, the feature descriptor may include the global descriptor in which the brightness, color, sharpness, gradient, scale, pattern information, etc., for the entire image or each region into which an image is divided based on arbitrary criteria or each feature area converted into vector values and extracted.

For example, the feature descriptor may include the frequency descriptor in which the number of previously divided specific descriptors included in an image, the number of global features such as a previously defined color table, etc., are converted into vector values and extracted, the binary descriptor in which whether each descriptor is included or whether the size of each element constituting the descriptor is larger or smaller than a specific value is extracted in units of bits, and then converted into an integer type and used, and a neural network descriptor in which image information used for learning or classification from a layer of a neural network is extracted.

Furthermore, according to the embodiment of the present invention, it is possible to convert the feature information vector extracted from the product image to a low dimension. For example, feature information extracted through an artificial neural network corresponds to high-dimensional vector information of 40,000 dimensions, and it is appropriate to convert the feature information into a low-dimensional vector of an appropriate range in consideration of resources required for the search.

For the conversion of the feature information vector, various dimensionality reduction algorithms such as principal component analysis (PCA) and zero-phase component analysis (ZCA) may be used, and the feature information converted into the low dimensional vector may be indexed into the corresponding product image.

Furthermore, the service server according to the embodiment of the present invention may extract a label for the meaning of the image by applying the machine learning technique based on the product image. The label may be expressed as an abstracted value or may be expressed in text form by interpreting the abstracted value (operation S803).

More specifically, according to a first embodiment of the present invention, the service server may define a label in advance, and generate a neural network model that trains features of an image corresponding to the label to classify an object in a product image and extract a label for the object. In this case, the service server may assign a label to an image that matches a specific pattern with random probability through the neural network model that has trained patterns of the images corresponding to each label.

According to a second embodiment of the present invention, the service server may train the features of the images corresponding to each label to form an initial neural network model, and apply a large number of product image objects to the initial neural network model to more elaborately extend the neural network model. Furthermore, when the corresponding product is not included in any group, the service server may generate a new group including the corresponding product.

According to the first and second embodiments, the service server may define labels in advance that may be used as meta information on products such as women's bottom, skirt, dress, short sleeve, long sleeve, pattern shape, material, color, and abstract feeling (innocence, chic, vintage, etc.), generate the neural network model that trains the features of the image corresponding to the label, and apply the neural network model to a product image of an advertiser to extract a label for an advertisement target product image.

Meanwhile, according to a third embodiment of the present invention, the service server may apply product images to the neural network model formed in a hierarchical structure formed of a plurality of layers without separately training the label. Furthermore, weights may be assigned to the feature information of the product image according to the request of the corresponding layer, and product images may be clustered using processed feature information.

In this case, additional analysis may be required to confirm whether the corresponding images are clustered according to any attribute of the feature value, that is, to connect the clustering result of the images with a concept that a human may actually recognize. For example, when the service server classifies products into three groups through the image processing and extracts label A for a first group feature, label B for a second group feature, and label C for a third group feature, it needs to be interpreted later that A, B, and C mean, for example, women's top, blouse, and checkered pattern, respectively.

According to the third embodiment, the service server may assign, to the clustered image group, a label that may be interpreted later into women's bottom, skirt, dress, short sleeve, long sleeve, pattern shape, material, color, abstract feeling (innocence, chic, vintage, etc.), and the like, and extract labels assigned to the image group to which individual product images belong as the label for the corresponding product image.

Meanwhile, the service server according to the embodiment of the present invention may express the label extracted from the product image as text, and the label in the text form may be utilized as tag information of a product.

In the past, the tag information of the product was subjectively and directly provided by a seller, and therefore was inaccurate and had low reliability. There was a problem in that the product tag subjectively assigned by the seller acted as noise and lowered the efficiency of the search.

However, as in the embodiment of the present invention, when the label information is extracted based on the product image and the extracted label information is converted into text and used as the tag information of the corresponding product, the tag information of the product may be extracted mathematically without human intervention based on the image of the corresponding product, thereby increasing the reliability of the tag information and improving the accuracy of the search.

Furthermore, in operation S804, the service server may generate category information of the corresponding product based on the content of the product image.

In the example of FIG. 8, operations S803 and S804 are illustrated as separate operations, but this is for convenience of description, and the present invention may not be construed as being limited thereto. According to the embodiment of the present invention, the label information and the category information may both be generated, but the label information may be used as the category information, and the category information may be used as the label information.

For example, when a label for a product image is extracted as women's top, blouse, linen, stripe, long sleeve, blue, or office look, the service server may use the labels for women's tops and blouses as the category information of the product, and use the labels for linen, stripe, long sleeve, blue, and office look as the label information to describe the features of the product in addition to the category. Alternatively, the service server may index the corresponding product without distinguishing between the label and the category information (operation S806).

In this case, the category information and/or the label of the product may be used as parameters for increasing the reliability of the image search.

Furthermore, the service server according to another embodiment of the present invention may determine the recommended item based on the label without separately calculating the image similarity.

Meanwhile, the service server according to the embodiment of the present invention may filter the collected product description image (operation S805). This is to configure a product image database excluding product images that may act as noise in the image search.

More specifically, the service server may determine whether to filter the product image by comparing the label extracted from the product image with the category and/or tag information directly provided by a seller.

According to the embodiment of the present invention, when there are a plurality of images for a specific product, and the label extracted from one of the images and the category assigned by the seller for the product are different, the corresponding image or a specific object within the corresponding image may be filtered in the database.

For example, there are first to third product images for product A, and a case in which labels for (women's top, jacket) in the first product image, (women's top, jacket) and (sunglasses, round) in the second product image, and (sunglasses, round) in the third product image are extracted may be considered. In this case, when the sales category of the product A is “sunglasses,” the service server may configure the product image database only with the second and third product images, excluding first product image.

This filtering is to reduce the noise of the image search. In the example above, the product A is actually about sunglasses. When the database is configured by including all of the first to third product description images, even when the query image is a jacket, it is determined that the query image is similar to the first product image, and thus the product A for sunglasses may be determined as an advertisement item. Therefore, the product images that may reduce the accuracy of the search are filtered and the database is constructed.

FIG. 9 is a flowchart for describing the generation of a style database of FIG. 7.

Referring to FIG. 9, in operation S901, the service server may collect style images online. For example, the service server may collect image information included in a website by collecting a list of web addresses of fashion magazines, fashion brands, drama production companies, celebrity agencies, SNSs, online stores, etc. and confirming the websites to track a link.

Meanwhile, the service server according to the embodiment of the present invention may collect and index images from websites such as fashion magazines, fashion brands, drama production companies, celebrity agencies, SNSs, and online stores, or may separately receive image information along with index information from an affiliated company.

In operation S902, the service server may filter out images inappropriate for style recommendation among the collected images.

For example, the service server may filter the remaining images while leaving only an image including a human-shaped object and a plurality of fashion items among the collected images.

Since the style image is used to determine other items that may be coordinated with a query item, it is appropriate to filter an image for a single fashion item. Furthermore, constructing a database with an image of a person directly wearing a plurality of fashion items may be more useful than an image of the fashion item itself. Therefore, the service server according to the embodiment of the present invention may determine the style image included in the style database by filtering the remaining images while leaving only an image including a human-shaped object and a plurality of fashion items.

Thereafter, the service server may process the features of the fashion item object image included in the style image (operation S903).

More specifically, the service server may extract image features of the fashion item object included in the style image, express the feature information as a vector value to generate a feature value of the fashion item object and structure feature information of the images.

Furthermore, the service server according to the embodiment of the present invention may extract a style label from the style image and cluster the style images based on the style label (operation S904).

It is appropriate to extract the style label as the look and feel and trend of the fashion item. According to the exemplary embodiment of the present invention, a label for a feeling that a person may feel in an appearance of a single fashion item included in a style image, a combination of a plurality of items, etc., may be extracted and used as a style label. For example, celebrity look, magazine look, summer look, feminine look, sexy look, office look, drama look, Chanel look, etc., may be exemplified as style labels.

According to the embodiment of the present invention, the service server may define the style label in advance, and generate a neural network model that trains features of an image corresponding to the label to classify an object in a style image and extract a label for the corresponding object. In this case, the service server may assign a label to an image that matches a specific pattern with random probability through the neural network model that has trained patterns of the images corresponding to each label.

According to another embodiment of the present invention, the service server may train the features of the images corresponding to each style label to form an initial neural network model, and apply a large number of style image objects to the initial neural network model to more elaborately extend the neural network model.

Meanwhile, according to another embodiment of the present invention, the service server may apply style images to the neural network model formed in a hierarchical structure formed of a plurality of layers without separately training the label. Furthermore, weights may be assigned to the feature information of the style image according to the request of the corresponding layer, product images may be clustered using the processed feature information, and labels interpreted later as celebrity look, magazine look, summer look, feminine look, sexy look, office look, drama look, Chanel look, etc., are assigned to the clustered image group.

In operation S905, the service server may cluster the style images using the style label, and generate a plurality of style books. This is intended to be provided as a reference to a user. The user may view a specific stylebook among a plurality of stylebooks provided by the service server and find a favorite item, and may request a product information search for the corresponding item.

Meanwhile, the service server may previously classify items having a very high appearance rate, such as a white shirt, jeans, and a black skirt, in operation S906.

For example, since jeans are a basic item in fashion, the appearance rates are very high in the style images. Therefore, whatever item the user inquires about, the probability that jeans will match as a coordination item will be significantly higher than that of other items.

Therefore, the service server according to the embodiment of the present invention may previously classify an item with a very high appearance rate in the style image as a buzz item in advance, and generate the stylebook with different versions including those with the buzz item and those without the buzz item.

According to another embodiment of the present invention, the buzz item may be classified by reflecting time information. For example, considering a fashion cycle of a fashion item, items that are fashionable for a short time of a month or two and then disappear, fashionable items that return every season, and items that are continuously popular for a certain period of time may be considered. Accordingly, when the time information is reflected in the classification of the buzz item and the appearance rate of a specific fashion item is very high for a certain period, the item may be classified as the buzz item together with information on the period. When the buzz items are classified in this way, in the subsequent item recommendation operation, there is an effect of being able to make a recommendation in consideration of whether the recommendation target item is in fashion or has nothing to do with fashion.

The embodiments of the present invention disclosed in the present specification and drawings merely provide specific examples to easily explain the technical content of the present invention and to aid understanding of the present invention, and are not intended to limit the scope of the present invention. It is obvious to those of ordinary skill in the art to which the present invention pertains that other modifications based on the technical idea of the present invention can be implemented in addition to the embodiments disclosed herein.

1. A service server comprising:
a product database configured to extract, for a product purchasable at an online market, a label which describes product details based on an image of the product, map the extracted label to the product, and store the extracted label;
a query processing unit configured to receive, upon selecting a search icon from a user device displaying a screen including a search target object and the search icon displayed around the search target object, a query to request recommended product information related to the search target object from the user device, recognize the search target object from the received query, and obtain a query label from the recognized search target object;
a feature label list providing unit configured to search, upon receiving the query label from the query processing unit, the product database for one or more candidate recommended products which are products tagged with the query label, generate a feature label list based on feature labels selected among feature labels tagged on the one or more candidate recommended products, and provide the feature label list to the user device; and
a product recommendation module configured to search the product database for a recommended product including a selected feature label, which is a feature label selected by a user from the feature label list and the query label, and provide recommended product information, which is information on the recommended product, to the user device,
wherein the feature label list provided to the user device is displayed around the search icon.

2. The service server of claim 1, further comprising
a counting execution unit configured to generate count information including information on a counted number for each of the feature labels tagged on the one or more candidate recommended products and provide the count information to the feature label list providing unit.

3. The service server of claim 2, wherein the counted number increases whenever the feature labels included in the feature label list are selected by the user, and
the counted number increases when the recommended product is search for with feature labels excluding the feature labels included in the feature label list among the feature labels tagged on the candidate recommended product.

4. The service server of claim 2, wherein the feature label list providing unit generates the feature label list based on at least one of an appearance frequency of each feature label and a counted number increase rate of each feature label among feature labels included in the one or more candidate recommended products, and
sorts the feature labels in order from the highest increase rate of the counted number among the feature labels included in the one or more candidate recommended products to generate the feature label list.

5. The service server of claim 2, wherein the feature label list providing unit generates the feature label list based on at least one of an appearance frequency of each feature label and a counted number increase rate of each feature label among feature labels tagged on the one or more candidate recommended products, and
generates the feature label list to include the preset number of feature labels in order from a highest increase rate of the counted number among the feature labels included in the one or more candidate recommended products to generate the feature label list.

6. The service server of claim 1, wherein the search icon is selected when a mouse cursor is located on the search icon or selected when the search icon is clicked.

7. The service server of claim 1, wherein the query processing unit receives, as a query, user IDs assigned to each user from the user device and searches a user database for preference labels reflecting a user's taste for fashion products matched with each user ID, and
the product recommendation module determines, upon receiving the preference label from the query processing unit, a product tagged with the preference label as a recommended product and provides the determined product to the user device.

8. The service server of claim 7, wherein the feature label list providing unit refers to, upon receiving at least one of the preference labels from the query processing unit, the user database to sort the preference labels according to a user's preference and provide the sorted preference labels as a list.

9. A method of operating a service server, the method comprising:
extracting, for a product purchasable at an online market, a label which describes product details based on an image of the product, mapping the extracted label to the product, and storing the extracted label in a product database;
receiving, upon selecting a search icon from a user device displaying a screen including a search target object and a search displayed around the search target object, a query to request recommended product information related to the search target object from the user device, recognizing the search target object from the received query, and obtaining a query label from the recognized search target object;
searching the product database for one or more candidate recommended products which are products tagged with the query label, generating a feature label list based on feature labels selected among feature labels tagged on the one or more candidate recommended products, and providing the feature label list to the user device; and
searching the product database for a recommended product including a selection feature label, which is a feature label selected by a user from the feature label list and the query label, and providing recommended product information, which is information on the recommended product, to the user device,
wherein the feature label list provided to the user device is displayed around the search icon.

10. The method of claim 9, further comprising:
generating count information including information on a counted number for each of the feature labels tagged on the one or more candidate recommended products; and
generating the feature label list based on at least one of an appearance frequency of each feature label and the count information of each of the feature labels among the feature labels tagged on the one or more candidate recommended products.

11. The method of claim 10, wherein the counted number increase whenever the feature labels included in the feature label list are selected by the user; and
the count number increase when the recommended product is searched for with feature labels excluding the feature labels included in the feature label list among the feature labels tagged on the candidate recommended product.

12. The method of claim 10, wherein the generating of the feature label list includes sorting the feature labels in order from the highest increase rate of the counted number among the feature labels included in the one or more candidate recommended products to generate the feature label list.

13. The method of claim 10, wherein the generating of the feature label list includes generating the feature label list to include the preset number of feature labels in order from a highest increase rate of the counted number among the feature labels included in the one or more candidate recommended products to generate the feature label list.

14. The method of claim 9, wherein the search icon is selected when a mouse cursor is located on the search icon or selected when the search icon is clicked.

15. The method of claim 9, further comprising:
receiving, as a query, user IDs assigned to each user from the user device and searching a user database for preference labels reflecting a user's taste for fashion products matched with each user ID; and
determining, upon receiving the preference label, a product tagged with the preference label as a recommended product and providing the determined product to the user device.

16. The method of claim 15, further comprising referring to, upon receiving the at least one or more preference labels, the user database to sort the preference labels according to a user's preference and provide the sorted preference labels as a list.

17. A computer-readable medium in which a computer program for executing the method of claim 9 is stored.
